(19) United States
(12) Patent Application Publication
(10) Pub. No.: US 2026/0099430 A1
(43) Pub. Date: Apr. 9, 2026

(54) SYSTEMS AND METHODS FOR REAL-TIME ADAPTIVE EXPERIMENT MANAGEMENT ON SOFTWARE APPLICATIONS

(71) Applicant: Convert Insights, Inc., Claymont, DE (US)

(72) Inventors: Dennis van der Heijden, Denia(Alicante) (ES); Karim Naufal, Javea/Xabia (ES); Cheneba Akonwie Siben Ngala, Southwest Region (CM); Usman Abbas, Karachi (PK)

(21) Appl. No.: 19/349,965

(22) Filed: Oct. 4, 2025

Related U.S. Application Data
(60) Provisional application No. 63/703,551, filed on Oct. 4, 2024.

(51) Int. Cl. G06F 11/3668

(52) U.S. Cl. CPC G06F 11/3684

(57) ABSTRACT

A system and method for adaptive management of real-time online experiments using statistical modeling, anomaly detection, and automated parameter adjustment is provided. The system receives experiment data including start time, current progress, historical metrics, user behavior, and configuration parameters. It detects anomalies in the data using machine learning techniques. A projected completion time is computed using statistical models, including Frequentist and Bayesian approaches, by performing analyses such as t-tests, power calculations, and risk-chance evaluations via Monte Carlo simulations. The system applies variance reduction techniques (CUPED) and determines whether adjustment conditions are met based on experiment status, statistical thresholds, or observed deviations. If conditions are met, it dynamically modifies duration, sample size, or confidence thresholds, and generates updated configurations. The system operates in real time and supports API integration and user interface presentation, enabling intelligent control of experiments on software applications with minimal manual oversight.

### CROSS-REFERENCE TO RELATED APPLICATION

This application claims the benefit of U.S. Provisional Patent Application Ser. No. 63/703,551 filed on Oct. 4, 2024, which is incorporated herein by reference in its entirety.

### FIELD OF INVENTION

The present invention relates generally to the field of digital experimentation and data analytics. More particularly, to systems and methods for testing the performance of software applications by adaptively managing online experiments on the software applications and for providing live duration insights.

### BACKGROUND

Modern software applications, especially those delivered through the web or mobile environments, are frequently updated and optimized through controlled experiments such as A/B testing, multivariate testing, and split testing. These experiments help product teams evaluate user behavior in response to design changes, feature updates, or new offerings. However, conducting these experiments reliably and efficiently poses significant challenges.

One major challenge is estimating the appropriate duration of an experiment. Rigid experiment timelines can lead to premature decisions or unnecessarily long tests, both of which reduce efficiency and decision accuracy. In many cases, statistical significance thresholds are either overestimated or underestimated, leading to invalid conclusions.

Another issue is the difficulty in managing variance within experiment data. Random fluctuations in user behavior, uneven user distribution, and environmental changes can all introduce statistical noise. While variance reduction techniques exist, they are often underutilized or applied inconsistently.

Additionally, online experiments often rely on static configurations, with little to no adjustment once the experiment has launched. This rigid structure fails to account for dynamic shifts in traffic, conversion behavior, or other contextual changes. Without adaptive mechanisms, valuable time and resources may be wasted on experiments that are underpowered or misconfigured.

Further, anomaly detection is another vital but overlooked component. Real-time spikes, drops, or inconsistencies, whether due to bots, infrastructure failures, or seasonal effects, can skew experiment results if not identified and mitigated in a timely manner.

Traditional experimentation systems primarily rely on Frequentist statistical approaches and pre-defined power calculations. While effective in simple scenarios, these methods lack flexibility. Bayesian statistical methods, which provide probabilistic insights and dynamic updating capabilities, are often not integrated or are reserved for expert use due to their complexity.

Moreover, existing systems do not sufficiently leverage pre-experiment data to improve experiment quality. Techniques such as Controlled-experiment Using Pre-Experiment Data (CUPED), which reduce variance by adjusting for historical user behavior, are rarely built into experimentation platforms in a modular and scalable way.

Accordingly, there exists a need for an intelligent and adaptive experiment management system that can overcome one or more of the aforementioned issues.

### SUMMARY

The present disclosure provides a computer-implemented method and system for adaptive experiment management in an application environment. The method comprises receiving data related to an ongoing experiment, including start time, current progress, historical metrics, configuration parameters, and user behavior data. The system detects anomalies in the received data using one or more machine learning models and estimates a projected completion time for the experiment by applying one or more statistical methods, including Frequentist or Bayesian models. Based on this analysis, the method determines whether adjustment conditions are satisfied, and if so, automatically modifies one or more experiment parameters, such as duration, sample size, or statistical thresholds and generates corresponding updated parameters. These updates may be logged for audit and model improvement and displayed via a graphical user interface or transmitted through an API.

Further, the system supports advanced statistical computations, including power analysis, multiple comparison corrections, and variance reduction techniques such as CUPED. In Bayesian implementations, the system calculates chance-to-win and risk values, along with a combined progress metric, based on observed behavior data, Monte Carlo simulations, and real-time metrics. Machine learning models, such as isolation forests or EWMA control charts, are used to detect outliers and anomalies. The system may operate within a cloud-based analytics platform and execute updates at sub-15-minute intervals, enabling near real-time adaptation. This allows dynamic control of experiment conditions across different devices and environments while ensuring statistical rigor and user engagement monitoring.

The disclosed method and system overcome limitations of static experiment configurations and manual intervention by providing real-time, automated experiment management. The invention enables more accurate, efficient, and scalable A/B or multivariate testing across versions of software applications, referred to as units under test (UUTs), while maintaining statistical integrity. Further, the method and associated system allows contextual decisions to be made dynamically based on changing traffic patterns, variability, or experiment progress.

These and other objects, features, and advantages of the present invention will become more readily apparent from the following detailed description of the embodiments and the accompanying drawings.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout.

FIG. 1 is a block diagram depicting a system/environment in accordance with embodiments of the disclosure.

FIG. 2 depicts a system including an experiment control tool, in accordance with embodiments described herein.

FIG. 3 depicts a flowchart of a method to determine a real-time duration estimate for an experiment on an online unit under test (UUT), in accordance with one or more embodiments of this disclosure.

FIG. 4 depicts a flowchart of a method to conduct an experiment on an online unit under test (UUT), in accordance with one or more embodiments of this disclosure.

### DETAILED DESCRIPTION

This disclosure recognizes and addresses, among other technical challenges, the issue of online experiments, including an A/A test, an A/B test, an ABn test, a split uniform resource locator (URL) test, a multivariate test, a multi-page test, other types of tests, or any combination thereof. An A/B Test compares two versions (A and B) of a single variable, like a webpage element or email subject line. Users may be randomly shown one version to determine which performs better. An A/A Test is similar to the A/B test, except both groups see the same version. This MAY be used to validate testing methodology and establish a baseline for future experiments. An A/B/n Test may compares more than two variations of a single element. “n” may represent the number of versions being tested simultaneously. A split test is often used interchangeably with A/B testing, but can refer to testing entirely different page designs or concepts rather than just one element. A multivariate test may be implemented to evaluate multiple variables simultaneously to determine the best combination of changes. This may be more complex than A/B testing, but can yield deeper insights. A multi-page test may examine changes across multiple pages or steps in a user journey, rather than on a single page.

Embodiments of the disclosure, individually or in combination, include computing systems, computing devices, computer-program products and computer-implemented methods that advance online experiments through advanced, real-time duration estimation and an adaptive adjustment mechanism. The system may continuously monitor experiment progress and/or predict completion time, and may automatically adjust experiment parameters to ensure optimal outcomes. In some examples, the system may support both Frequentist and Bayesian statistical approaches, and may incorporate advanced techniques such as controlled-experiment using preexperiment data (CUPED) for improved accuracy and efficiency.

Although embodiments of this disclosure are illustrated with reference to online experiments, the principles and practical applications of this disclosure are not limited to neither one of those. Indeed, the underlying mechanisms of monitoring and adjusting experiment parameters may be applied to other types of experiments.

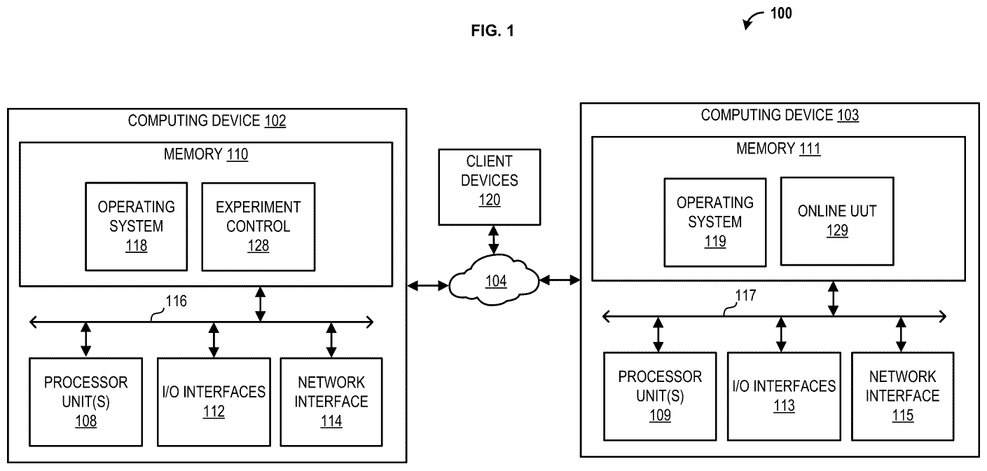

FIG. 1 is a block diagram depicting a system/environment 100 in accordance with embodiments of the disclosure. The system 100 may include non-limiting examples of a computing device (or server) 102, a computing device (or server) 103, and one or more client devices 120 connected through a network 104. In an aspect, some or all steps of any described method may be performed on a computing device as described herein. In some examples, the computing device (or server) 102, the computing device (or server) 103, and the one or more client devices 120 may each include one or more devices capable of operating based on processor-executable instructions, such as computers, laptop computers, tablet computers, smartphones, cellular phones, wearable devices, internet-connected devices, etc. In some examples, In some examples, one or more of the computing device (or server) 102, the computing device (or server) 103, and the one or more client devices 120 may operate as virtualized computing devices hosted on one or more local or remote servers or computers, including cloud computing systems. While FIG. 1 depicts the computing device (or server) 102, the computing device (or server) 103, and the one or more client devices 120, it is appreciated that the system could include more computing devices or servers or client devices or could include functionality of the computing device (or server) 102, the computing device (or server) 103, and/or the one or more client devices 120 in a single device or system without departing from the scope of the disclosure.

The computing device 103 may comprise one or multiple computers configured to store instructions for a unit under test (UUT) 129 to implement the functionality of the interface described herein. The computing device 102 may comprise one or multiple computers configured to store instructions for an experiment control tool 128 to implement the functionality of the experiment control tool described herein. In some examples, at least some of the components of the experiment control tool 128 could be implemented or hosted on the computing device 103 and/or one or more of the client devices 120 during the experiment without departing from the scope of the disclosure. The one or more client devices may comprise one or multiple computers configured to store instructions for to access the UUT 129 described herein. The UUT 129 may include web applications accessible through various web browsers on computers, laptop computers, tablet computers, smartphones, cellular phones, wearable devices, internet-connected devices, etc., as well as native mobile applications on computers, laptop computers, tablet computers, smartphones, cellular phones, wearable devices, internet-connected devices, etc. IN some examples, a portion of the experiment control tool 128 could be installed on the client devices 120, such as a plug-in or extension installed on a browser used to test the UUT 129. Multiple computing devices 102, 103, and/or 120 may communicate through the network 104.

The computing device 102 may be a digital computer that, in terms of hardware architecture, generally includes one or more processor units 108, system memory 110, input/output (I/O) interfaces 112, and network interfaces 114. These components (108, 110, 112, and 114) are communicatively coupled via a local interface 116. The local interface 116 may be, for example, but not limited to, one or more buses or other wired or wireless connections, as is known in the art. The local interface 116 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

Similar to the computing device 102, the computing device 103 may be a digital computer that, in terms of hardware architecture, generally includes one or more processor units 109, system memory 111, input/output (I/O) interfaces 113, and network interfaces 115. These components (109, 111, 113, and 115) are communicatively coupled via a local interface 117. The local interface 117 may be, for example, but not limited to, one or more buses or other wired or wireless connections, as is known in the art. The local interface 117 may have additional elements, which are omitted for simplicity, such as controllers, buffers (caches), drivers, repeaters, and receivers, to enable communications. Further, the local interface may include address, control, and/or data connections to enable appropriate communications among the aforementioned components. It is appreciated that the one or more client devices 120 may include components similar to the components of the computing device 102 and/or the computing device 103 without departing from the scope of the disclosure. A detailed depiction of these components is not shown in the interest of simplicity and brevity.

The one or more processor units 108 and/or 109 may be a hardware device for executing software, particularly that stored in system memory 110 or 111, respectively. The one or more processor units 108 and/or 109 may include any custom made or commercially available processor, a central processing unit (CPU), an auxiliary processor among several processors associated with the computing device 102 and the computing device 103, a semiconductor-based microprocessor (in the form of a microchip or chip set), or generally any device for executing software instructions. During operation of the computing device 102 and/or the computing device 103, the one or more processor units 108 and/or 109, respectively, may execute software stored within the system memory 110 or 111, to communicate data to and from the system memory 110 or 111, and to generally control operations of the computing device 102 and the computing device 103, respectively, pursuant to the software.

The I/O interfaces 112 and/or 113 may be used to receive user input from, and/or for sending system output to, one or more devices or components. User input may be received via, for example, a keyboard, a mouse, touch, speech or audio, gesture, or any other user input method, device, or system. System output may be output via a display device and a printer (not shown). I/O interfaces 112 and/or 113 may include, for example, a serial port, a parallel port, a Small Computer System Interface (SCSI), an infrared (IR) interface, a radio frequency (RF) interface, and/or a universal serial bus (USB) interface.

The network interface 114 and/or 115 may be used to transmit and receive from the computing device 102 and/or the computing device 103, respectively, on the network 104. The network interface 114 and/or 115 may include, for example, a 10BaseT Ethernet Adaptor, a 10BaseT Ethernet Adaptor, a LAN PHY Ethernet Adaptor, Gigabit Ethernet adaptor, a Token Ring Adaptor, a wireless network adapter (e.g., Wi-Fi (e.g., IEEE 802.11 standard adaptors), cellular (e.g., 3GPP standard adaptors), satellite), or any other suitable network interface device. The network interface 114 and/or 115 may include address, control, and/or data connections to enable appropriate communications on the network 104.

The system memory 110 and/or 111 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 110 and/or 111 may incorporate electronic, magnetic, optical, and/or other types of storage media. Note that the system memory 110 and/or 111 may have a distributed architecture, where various components are situated remote from one another, but may be accessed by the one or more processor units 108 and/or 109.

The software in system memory 110 and/or 111 may include one or more software programs, each of which comprises an ordered listing of executable instructions for implementing logical functions. In the example of FIG. 1, the software in the system memory 111 of the computing device 103 may comprise instructions for the UUT 129, and a suitable operating system (O/S) 118. In the example of FIG. 1, the software in the system memory 111 of the computing device 103 may comprise instructions to cause display one or more versions of an online resource, such as a website, an online store or marketplace, an application hosted on a client device of the one or more client devices 120, or any combination thereof. The operating system 119 essentially controls the execution of other computer programs. In some examples, the operating system 119 supports virtualization of various components of the system 100, including container-based platforms, orchestration platforms, virtual machines, etc.

In the example of FIG. 1, the software in the system memory 110 of the computing device 102 may comprise instructions for the experiment control tool 128, and a suitable operating system (O/S) 118. In the example of FIG. 1, the software in the system memory 110 of the computing device 102 may comprise instructions to monitor and control an experiment on the UUT 129 based on interactions between the UUT 129 and inputs from the one or more client devices 120. The operating system 119 essentially controls the execution of other computer programs. In some examples, the operating system 118 is a hypervisor configured to host virtual machines or containers to support virtualization.

For purposes of illustration, application programs and other executable program components such as the operating system 118 and 119 are shown herein as discrete blocks, although it is recognized that such programs and components may reside at various times in different storage components of the computing device 102 and/or the computing device 103. An implementation of the system/environment 100 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

In operation, the computing device 103 may cause the UUT 129 to be accessible to the one or more client devices 120. The computing device 102 may cause the experiment control tool 128 to perform certain experiments on the UUT 129 and to receive data indicative of interactions between the one or more client devices 120 and the UUT 129 to monitor and control the experiments in order to evaluate progress of the experiment being run on the UUT 129. The experiment control tool 128 may communicate with the UUT 129 to detect status of the UUT 120, control or detect which versions of the UUT 129 is presented, monitor user interaction from the one or more client devices 120, such as selection locations within the user interface of the UUT 129, amount of time on a screen of or time to complete a transaction using the UUT 129, etc. In some examples, the experiment control tool 128 may provide, real-time duration estimation and adaptive adjustment mechanism for experiments (e.g., online or offline) of the UUT 129, including A/B tests, AA tests, ABn tests, split tests, multi-page tests, multivariate tests, etc.

The experiment control tool 128 may also process the data received from the UUT 129 to determine various metrics associated with the experiment. Using the processed data, the experiment control tool 128 may automatically adjust parameters of the experiment, provide visual and/or audible alerts, cause display of information related to the experiment, or any combination thereof. The type of information may include a count of client device interactions, a total, average, maximum, and/or minimum amount of time the one or more client devices interact with the UUT 129, an estimated time remaining on the experiment.

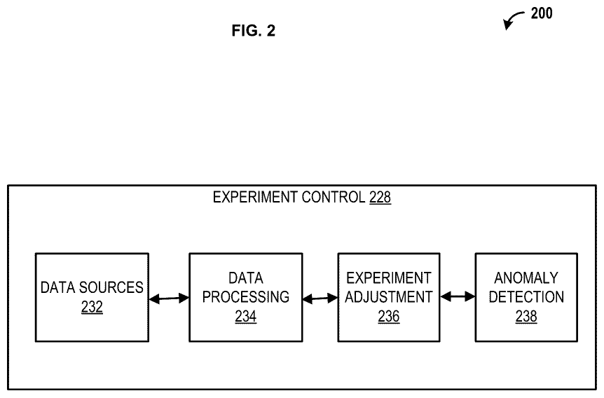

FIG. 2 depicts a system 200 that includes an experiment control tool 228, in accordance with embodiments described herein. The experiment control tool 228 may be implemented in the experiment control tool 128 of FIG. 1, in some examples. The experiment control tool 228 may include a data sources system 232, a data processing system 234, an experiment adjustment system 236, and an anomaly detection system 238.

For the experiment, the data sources system 232 may retrieve data from various data sources, including from local storage and/or may from an UUT, such as the UUT 129 of FIG. 1. In some examples, the data sources system 232 may receive, initial data inputs, a start date for the experiment, estimated progress, remaining samples, historical volume/count data, audience knowledge, goals/key performance indicators (KPIs), metrics of the experiment, conversion rates, experiment parameters, pre-experiment data (e.g., if CUPED is enabled), continuous data collection, user interactions, conversion events, timing data, user attributes, etc., or any combination thereof.

The data processing system 234 may process data from the data sources system 232 to track progress and evaluate results. For example, the data processing system 234 may perform data preprocessing, statistical approach selection and implementation, a Frequentist statistical approach and/or a Bayesian statistical approach (e.g., including Monte Carlo simulations), an elapsed time calculation, a sample collection rate determination, a Frequentist progress calculation, an estimated remaining time calculation, a project completion date prediction, statistical methods calculations, a CUPED adjustment (optional), a Bayesian chance to win progress calculation, a Bayesian risk progress calculation, a combined progress calculation, a real-time update calculation, a dynamic recalculation calculation, an adaptive statistical analysis, anomalies detection, a feedback loop analysis, etc., or any combination thereof. Other types of data processing may be employed by the data processing system 234 without departing from the scope of the disclosure.

The experiment adjustment system 236 may facilitate adjustments to the experiment based on information processed by the data processing system 234. For example, the experiment adjustment system 236 may include an automatic adjustment system that evaluates a current state of the experiment and the UUT against triggers (e.g., predefined states or actions that cause an action to be taken), identifies activated triggers, determines potential adjustments to the experiment, applies the adjustments, and re-calculate duration estimation after the updates.

The anomaly detection system 238 may facilitate enhanced anomaly detection and outlier removal. For example, the anomaly detection system 238 may apply statistical process control (SPC) charts, use seasonal decomposition, use isolation forests, perform multi-method detection and consensus filtering, conduct impact analysis and removal decision-making, implement adaptive thresholds, etc., or any combination thereof.

In certain embodiments, the anomaly detection system 238 is not limited to generic outlier identification techniques, but instead provides a context-aware anomaly detection framework specifically optimized for experimentation workflows. The purpose of anomaly detection in this system includes several critical functions: real-time monitoring of key experiment metrics such as conversion rates, traffic volume, and engagement; triggering alerts when those metrics deviate beyond expected bounds (e.g., a 3× standard deviation jump in conversions or sudden traffic surges); and performing automated filtering of corrupted or non-representative sessions—such as those caused by bot traffic, rage clicks, partial page loads, or instrumentation glitches. Such anomalous sessions may be tagged and retained for forensic review but are excluded from downstream statistical analysis. In cases where anomalies persist, the system may proactively pause the affected experiment or adjust key parameters, such as reducing or halting traffic to a broken variant.

The anomaly detection mechanism employed by the system is a hybrid and adaptive architecture that integrates multiple statistical and machine learning techniques in a coordinated pipeline. For example, it may combine Exponentially Weighted Moving Average (EWMA) control charts for trend drift detection, Seasonal-Trend decomposition using Loess (STL) for seasonal pattern recognition, and machine learning models such as Isolation Forests or Local Outlier Factor (LOF) for identifying unusual behavior in multivariate data. This hybrid model distinguishes between normal experimental noise and genuine threats to data integrity, such as sudden user spikes due to marketing campaigns or traffic anomalies specific to one variant. Adaptive thresholds are employed dynamically across the experiment lifecycle: looser thresholds may be used during ramp-up periods where variance is naturally high, while tighter thresholds are enforced once the test stabilizes. This adaptivity extends to metric-specific behavior, accounting for the differences between, for example, engagement metrics versus binary conversion events. The system may also segment anomaly detection by dimensions such as device type or user geography to improve granularity.

To further reduce false positives and improve decision reliability, the system may implement real-time ensemble filtering in which multiple anomaly detectors operate in parallel, and actions are taken only when two or more detectors concur. Over time, detected anomalies may be labeled by analysts as true or false positives, creating a supervised feedback loop that incrementally improves the accuracy and responsiveness of the system. These characteristics collectively enable a self-learning, experiment-aware anomaly detection framework tailored to maintaining A/B testing fidelity.

In terms of its internal architecture, the anomaly detection system 238 employs a specialized pipeline and feature engineering approach that distinguishes it from standard, off-the-shelf detection frameworks. Raw events entering the pipeline may be enriched with experiment-specific metadata such as variant assignment, current allocation ratios, and experiment maturity stage. This allows the detection logic to differentiate natural fluctuations from behavior indicating experimental instability. Features engineered for detection may include variant-specific interaction patterns, abnormal session flow disruptions, and behavior changes that differ across devices or user segments. Furthermore, the alerting system used in conjunction with anomaly detection is also experiment-aware. Instead of simple threshold alerts, the system dynamically prioritizes and routes alerts based on the severity and context of the anomaly. For instance, a critical failure in one variant may trigger an immediate, high-urgency alert via Slack or another messaging platform, while a slow, low-impact drift may be deferred to a weekly summary log. This alert escalation framework helps teams respond efficiently to anomalies with the appropriate level of urgency, ensuring continued trust in experimentation results.

The experiment control tool 228 may present information to a user via a user interface (e.g., visual, aural, vibration, interactive, etc.), such as presenting a visual progress bar for the experiment that is automatically updated, general notifications (e.g., text, graphical, speech, popup, etc.), present details when various elements of the progress bar or another component of the user interface are hovered over, provide warnings (visual and/or aural), provide an ability for one-click (e.g., or multi-click) adjustment of one or more parameters of the experiment, facilitate integration with third party software, etc., or any combination thereof.

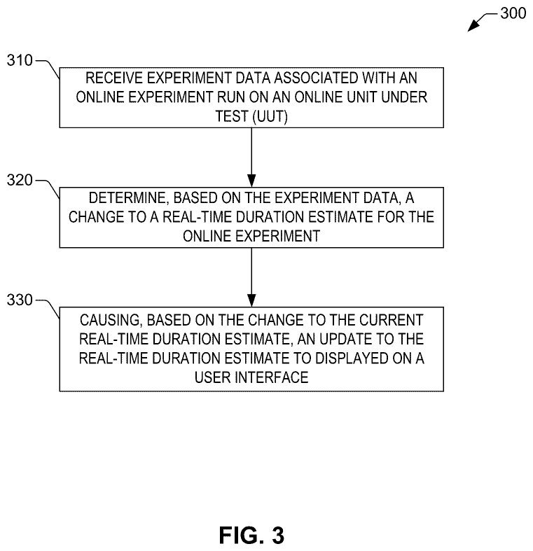

FIG. 3 depicts a flowchart of a method 300 to determine a real-time duration estimate for an online experiment on an online unit under test (UUT), in accordance with one or more embodiments of this disclosure. A computing device or a system of computing devices can implement the example method 300 in its entirety or in part. For example, the computing device 102 of FIG. 1 and/or the experiment control tool 228 of FIG. 2 may implement the method 300.

The method 300 may include receiving experiment data associated with an online experiment run on an online unit under test (UUT), at 310. In some examples, the online experiment includes one or more of A/B tests, AA tests, ABD tests, split tests, multi-page tests, multivariate tests, etc. In some examples, the UUT includes one or more web-pages, one or more online marketplaces, one or more online stores, one or more mobile applications, or any combination thereof.

The method 300 may further include determining, based on the experiment data, a change to a real-time duration estimate, at 320. In some examples, the method 300 may further include performing at least one of a t-test, a one-tailed test, a two-tailed test (or ANOVA, Chi-square, non-parametric, etc.) to determine the change to the real-time duration estimate. In some examples, the method 300 may further include performing a multiple comparison correction to control an error rate to determine the change to the real-time duration estimate. In some examples, the method 300 may further include performing a power calculation to determine the effect of sample sizes to determine the change to the real-time duration estimate. In some examples, the method 300 may further include adjusting the experiment data based on pre-experiment data to determine the change to the real-time duration estimate. In some examples, the method 300 may further include determining the change to the real-time duration estimate using a Bayesian statistical process. The Bayesian statistical process may include determining, based on the experiment data, chance progress of the online experiment relative to a control; determining, based on the experiment data, risk progress of the online experiment relative to a target risk; and determining, based the risk progress and the chance progress, a combined progress. The risk progress, the chance progress, and/or the combined progress of the Bayesian model may be determined based on Monte Carlo simulations, machine learning models, hierarchical models, or any other statistical model. The combined progress is used to determine the change to the real-time duration estimate. In some examples, the method 300 may further include determining the change to the real-time duration estimate based on the combined progress and an elapsed time from the start of the online experiment. In some examples, the method 300 may further include determining the change to the real-time duration estimate based on a proximity to completion of the online experiment, unexpected variability in the online experiment, low conversion rates for the online experiment, time constraints associated with the online experiment.

The method 300 may further include causing, based on the change to the current real-time duration estimate, an update to the real-time duration estimate communicated on a user interface, at 330. In some examples, the user interface may include a progress bar, a timer, or a combination thereof, to display an indication of the real-time duration estimate. In some examples, the user interface may also communicate recommendations to a user for actions to perform or to avoid performing. The user interface is responsive and adapts to various screen sizes, from desktop monitors to smartphone displays, ensuring consistent functionality across devices.

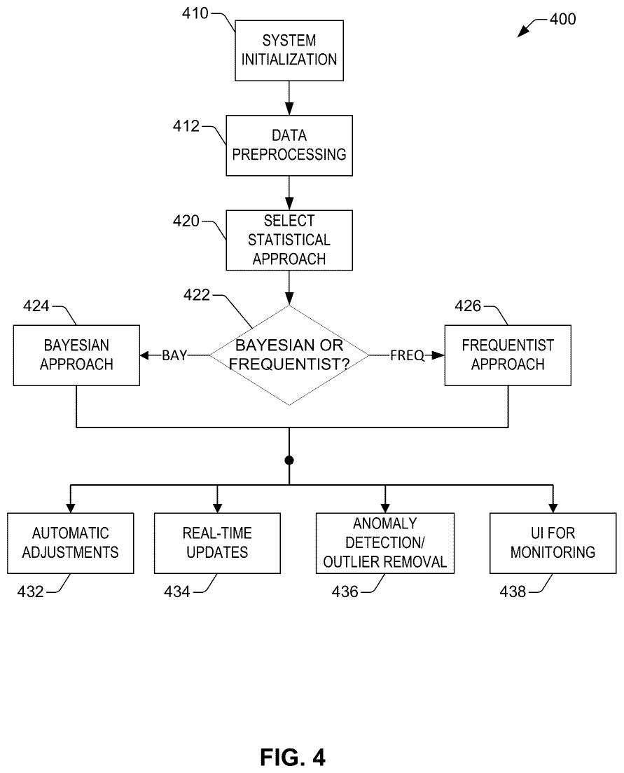

FIG. 4 depicts a flowchart of a method 400 to conduct an online experiment on an online unit under test (UUT), in accordance with one or more embodiments of this disclosure. A computing device or a system of computing devices can implement the example method 400 in its entirety or in part. For example, the computing device 102 of FIG. 1 and/or the experiment control tool 228 of FIG. 2 may implement the method 400.

The method 400 may include initializing the system, at 410. Initializing the system may include collecting initial data inputs, determining a start date, receiving data indicative of estimated progress, remaining samples, historical volume/count data, audience knowledge, goals/KPIs, conversion rates, metrics, receive experiment parameters, receive pre-experiment data (e.g., if CUPED is enabled), or any combination thereof.

The method 400 may further include preprocessing data, at 412. The data preprocessing may include validating and preprocessing data inputs.

The method 400 may further include selecting a statistical approach, at 420. The method 400 may further include determining, at 422, a selection of one of the Bayesian approach, at 424, or the frequentist approach, at 426. The frequentist approach may include: calculating elapsed time, determining a sample collection rate, estimating a remaining time, projecting or predicting a project completion date, performing statistical methods (e.g., t-tests, one-tailed/two-tailed tests, multiple comparison correction, power calculation, etc.), applying a CUPED adjustment (if enabled), or any combination thereof. The Bayesian approach may include: calculating chance progress, calculating risk progress, calculating combined progress, calculating elapsed time, estimating a remaining time, projecting or predicting a project completion date, performing statistical methods (e.g., update posterior distributions and decision thresholds, etc.), applying a CUPED adjustment (if enabled), or any combination thereof.

In some embodiments, the statistical estimation engine may dynamically select from a portfolio of statistical techniques based on experiment conditions, traffic patterns, and metric types. The selected statistical approach enables efficient, adaptive estimation and decision-making. Frequentist methods, such as t-tests and ANOVA, are advantageous for early detection of statistically significant differences across experiment variants, particularly when the system operates in high-traffic conditions and a binary success metric (e.g., conversion) is present. These methods support quick validation of hypotheses and control for false positives through multiple comparison corrections or power calculations. Additionally, power analysis may be used to assess whether sufficient data have been collected to reach reliable conclusions, thereby preventing premature stops or unnecessarily prolonged experiments.

CUPED variance reduction techniques are optionally applied when pre-experiment covariates are available. CUPED helps lower experimental noise by adjusting outcome metrics based on user-level pre-treatment behavior (e.g., historical purchase or engagement metrics). This enables the system to reach statistical significance with smaller sample sizes and provides more stable estimates of treatment effects.

For scenarios requiring continuous monitoring, low traffic, or uncertainty modeling, the system may instead adopt a Bayesian estimation approach. Bayesian methods, such as chance-to-be-best and risk scoring, provide a continuous measure of a variant's likelihood to outperform others while quantifying associated risk. These metrics are more intuitive and flexible than rigid p-values and enable mid-experiment traffic reallocation or early termination of poorly performing variants. Bayesian methods incorporate uncertainty into posterior distributions, yielding probabilistic outcomes that are better suited for real-time decisions under dynamic conditions.]

The choice between Frequentist, CUPED-enhanced Frequentist, Bayesian, or hybrid models is determined by real-time factors. For example, the system defaults to Frequentist approaches for fast, stable decisions when traffic is high and data is well-behaved. In contrast, if variance is high, traffic is sparse, or prior data is available, Bayesian and CUPED methods may be prioritized. For complex tests involving nonlinear interactions or multi-metric dependencies, the engine may invoke machine learning models capable of detecting nuanced effects without needing to wait for global significance thresholds.

In a preferred embodiment, the system operates on streaming batches of data, typically aggregated every one to five minutes. Each incoming event is associated with metadata such as user ID, variant assignment, timestamp, device type, geography, and experiment metrics (e.g., revenue, conversion flags, engagement time). A preprocessing module removes corrupted or invalid sessions based on defined criteria such as improbable session lengths, extreme outliers, or bot indicators.

When CUPED is active, the system computes the adjustment by calculating a covariance coefficient θ=Cov(Y,X)/Var(X), where Y is the post-experiment metric and X is the pre-treatment covariate. The adjusted metric becomes Y_adj=Y−θX, which is then used in subsequent significance tests or Bayesian updates.

For binary metrics like conversion, Bayesian inference is conducted using Beta-Bernoulli models. Priors may be uninformative (α=1, β=1) or informative based on historical test data. Posterior distributions are updated after each batch, and metrics such as P(Variant A>Variant B), credible intervals, and expected loss are calculated. For continuous metrics such as revenue, Gaussian models with Normal-Inverse-Gamma priors are employed. The engine updates posterior means and variances incrementally as new data arrives.

Decision logic is triggered when statistical criteria are met. For instance, if a variant's chance-to-be-best exceeds 95% and the expected downside risk is within acceptable thresholds (e.g., less than 1% projected revenue loss), the system may flag the variant for early promotion or reallocation. Conversely, underperforming variants may be throttled or paused. These decision points are reinforced by real-time anomaly detection (as described in paragraph [0031A]-[0031D]), which monitors for data integrity issues and can override statistical outputs if anomalies compromise the experiment's reliability.

The method 400 may further include performing automatic adjustments to the online experiment, at 432. The automatic adjustments may be performed by identifying current state against triggers, identifying activated triggers, determining potential adjustments, applying adjustments, and re-running duration estimation.

The method 400 may further include providing real-time updates to the online experiment, at 434. The real-time updates may be based on continuous data collection, adaptive statistical analysis, dynamic recalculation, anomaly detection, and a feedback loop.

The method 400 may further include detecting anomalies and/or removing outliers from the online experiment, at 436. The detection of anomalies and removal of outliers may be implemented via application of SPC charts, seasonal decomposition, isolation forests, performance of multi-method detection consensus filtering, conducting impact analysis and removal decisions, implementing adaptive thresholds.

The method 400 may further include providing the user interface for monitoring the online experiment, a 438. The user interface may include a visual progress bar, hover-over details, a warning system, a one-click (or multi-click) adjustment module, and may support integration with third-party systems.

It is to be understood that the methods and systems described here are not limited to specific operations, processes, components, or structure described, or to the order or particular combination of such operations or components as described. It is also to be understood that the terminology used herein is for the purpose of describing example embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that may be performed or components that may be added, it is understood that each of these additional operations may be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, magnetic storage devices, Non-Volatile Random Access Memory (NVRAM), flash memory, or a combination thereof, whether internal, networked, or cloud-based.

Embodiments of this disclosure have been described with reference to diagrams, flowcharts, and other illustrations of computer-implemented methods, systems, apparatuses, and computer program products. Each block of the block diagrams and flowchart illustrations, and combinations of blocks in the block diagrams and flowchart illustrations, respectively, may be implemented by processor-accessible instructions. Such instructions may include, for example, computer program instructions (e.g., processor-readable and/or processor-executable instructions). The processor-accessible instructions may be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions may be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that may direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations may be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

Accordingly, blocks of the block diagrams and flowchart diagrams support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, may be implemented by special purpose hardware-based computer systems that perform the specified functions or operations, or combinations of special purpose hardware and computer instructions.

The methods and systems may employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order.

Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

### Examples

### System Overview

The Time to Done system may include an advanced, real-time duration estimation and adaptive adjustment mechanism for online experiments, including A/B tests, split URL tests, and multi-page tests. This system may continuously monitor experiment progress, predict completion time, and automatically adjust experiment parameters to ensure optimal outcomes. It may support both Frequentist and Bayesian statistical approaches, and may incorporate advanced techniques, such as CUPED (Controlled-experiment Using Pre-Experiment Data) for improved accuracy and efficiency.

Data Inputs and Preprocessing: The system may utilize the following data inputs:

Start Date: The date when the experiment commenced.

Estimated Progress: The current progress of the experiment, calculated differently for Frequentist and Bayesian approaches.

Remaining Samples: For Frequentist approach, the additional number of samples needed to achieve the desired statistical power and significance level.

Historical Volume/Count Data: Past data on traffic volumes, sessions, unique users, and conversion rates.

Audience Knowledge: Information on user location, device, operating system, and browser.

Goals/Key Performance Indicators (KPIs): Specific metrics being tracked in the experiment.

Conversion Rates: Current and historical conversion rates for the tracked goals.

Experiment Parameters: Including confidence level, test type (one-tailed or twotailed), and correction methods for Frequentist approach; chance to win and risk thresholds for Bayesian approach.

When CUPED is enabled, the system may also utilize pre-experiment data: Historical conversion rates, Past purchase amounts, Site usage metrics (e.g., page views, session duration), User attributes (e.g., account age, device type)

### Statistical Methods

### Frequentist Approach

### Duration Estimation Algorithm

### 1. Calculate Elapsed Time:

$$Elapsed Time ( days ) = Current Date - Start Date$$

### 2. Determine Sample Collection Rate:

$$Sample Collection Rate = ( Estimated Progress * Total Sample Size ) / Elapsed Time$$

### Where:

Estimated Progress: This may be calculated as the ratio of current samples to the total required sample size. For example, if we've collected 500 samples out of a required 1000, the Estimated Progress would be 0.5 or 50%.
Total Sample Size: This may be determined at the start of the experiment based on the desired statistical power, significance level, and minimum detectable effect. It's calculated using power analysis formulas specific to the type of test being conducted (e.g., t-test).

### 3. Estimate Remaining Time:

$$Remaining Time ( days ) = Remaining Samples / Sample$$

### Collection Rate Where:

Remaining Samples: This is the difference between the Total Sample Size and the number of samples collected so far. It's dynamically updated as new data comes in.

### 4. Project Completion Date:

$$Completion Date = Current Date + Remaining Time$$

### Statistical Methods

T-tests: The system may use t-tests to determine statistical significance. The specific type of t-test depends on the experiment design:

Independent two-sample t-test: May be used when comparing two separate groups (e.g., control vs. treatment).

Paired t-test: May be used when comparing before-and-after measurements on the same subjects. The t-statistic is calculated as: t=(\ddot{x}₁−\ddot{x}₂)/√(s₁²/n₁+s₂²/n₂) Where x1 and x2 are the sample means, s₁ and s₂ are the sample standard deviations, and n₁ and n₂ are the sample sizes.

One-tailed vs. Two-tailed Tests: The system may support both one-tailed and two-tailed tests: One-tailed test: May be used when we're only interested in an effect in one direction_(e.g., improvement over control); and Two-tailed test: May be used when we're interested in effects in either direction. The choice between one-tailed and two-tailed affects the critical values used to determine significance.

Multiple Comparison Correction: To control the familywise error rate when making multiple comparisons, the system may implement:
Bonferroni correction: Adjusts the p-value threshold by dividing it by the number of comparisons.
   Sidák correction: A more powerful alternative to Bonferroni, calculated as: α¹=1−(1−α)\hat{ }(1/m) Where α is the desired significance level and m is the number of comparisons.

Power Calculation Modes: The system may offer two power calculation modes:
Dynamic mode: Continuously updates the power calculation based on observed effect sizes. This allows for potential early stopping if a large effect is detected.
Fixed mode: Uses a predetermined effect size for power calculations, ensuring consistent sample size requirements throughout the experiment.

The power calculation itself may be based on the formula: Power=1−β=P(|T|>t_critical|H1 is true) Where β is the probability of a Type II error, and t_critical is determined by the chosen significance level.

Controlled-experiment Using Pre-Experiment Data (CUPED) Adjustment (Optional): When enabled, CUPED adjusts the experiment metrics using pre-experiment data:

$${Y}^{*} = Y - 0 \{ X - {μ}_{x} )$$

Where Y is the original metric, X is a covariate (pre-experiment data), μₓ is the mean of X, and θ is a coefficient chosen to minimize the variance of Y*.

The system may dynamically select the most effective covariates and updates the CUPED adjustment throughout the experiment.

A critical step in implementing CUPED may include selecting an appropriate window size for pre-experiment data collection. This window size, representing the duration of historical data gathered before the experiment, significantly may impact the effectiveness of variance reduction.

The guiding principle for this selection may include the correlation between pre experiment and current experimental data. A higher correlation between these datasets may be associated with greater potential for variance reduction, making the choice of window size crucial for optimizing CUPED's effectiveness.

### Bayesian Approach

### Progress Estimation Algorithm

### Calculate Chance Progress:

Chance Progress=min(Current Chance to Win/Target Chance to Win, 1.0) Where:
Current Chance to Win: This is calculated using Bayesian inference. It represents the probability that the treatment is better than the control, given the data observed so far.
Target Chance to Win: This is a preset threshold, typically set at 0.95 or higher, representing the desired level of confidence in the result.

### Calculate Risk Progress:

Risk Progress=1−min(Current Risk/Target Risk, 1.0) Where:
Current Risk: This is calculated as the probability that the treatment effect is below a certain threshold of practical significance.
Target Risk: This is a preset maximum acceptable risk level, typically set low (e.g., 0.05 or lower).

### Compute Combined Progress:

Combined Progress=0.5*Chance Progress+0.5*Risk Progress This may balance the goals of achieving high confidence in the result and minimizing the risk of an undesirable outcome.

### Duration Estimation Algorithm:

### Calculate Elapsed Time:

$$Elapsed Time ( days ) = Current Date - Start Date$$

### Estimate Remaining Time:

$$Remaining Time ( days ) = ( Elapsed Time / Combined Progress ) - Elapsed Time$$

This formula may assume that the rate of progress will remain consistent. It may adjust the estimate based on how quickly the experiment is approaching the combined goals of high confidence and low risk.

### Project Completion Date:

$$Completion Date = Current Date + Remaining Time$$

### Statistical Methods

Employs uninformative priors.
Updates posterior distributions as data accumulates.
Utilizes decision thresholds for “Chance to Win” and “Risk” metrics (from the statistics settings of the experience).

### CUPED in Bayesian Analysis

When CUPED is enabled, the Bayesian models may be updated with CUPED-adjusted metrics, potentially leading to faster convergence of posterior distributions.

### Real-Time Updates

The system may update predictions in real-time through the following mechanisms:

Continuous Data Collection: Constantly gathers new data, including:
User interactions (e.g., page views, clicks)
Conversion events
Timing data (e.g., session duration)
User attributes (e.g., device type, location)

This data may be processed in real-time, with a typical delay of less than 1 minute from event occurrence to data availability for analysis.

Dynamic Recalculation: The system may perform recalculations at regular intervals:
(Full recalculation: Every 6 hours
Quick updates: Every 15 minutes

### Estimate Remaining Time:

Quick updates may adjust the current estimates based on new data, while full recalculations re-run the entire statistical analysis.

### Adaptive Statistical Analysis: Frequentist Approach

The system may update:
Sample means and standard deviations
T-statistics and p-values
Power calculations based on observed effect sizes

### Bayesian Approach

The system may update:
Posterior distributions for treatment effects
Probability of being best (Chance to Win)
Expected loss calculations (Risk)

Anomaly Detection: The system may employ several methods to detect anomalies:
Moving average control charts to detect shifts in conversion rates
Seasonal decomposition to account for expected periodic variations
Isolation forests to detect outliers in high-dimensional data

When anomalies are detected, the system can:
Trigger alerts for manual review
Automatically adjust experiment parameters
Exclude anomalous data from primary analysis but flag it for separate investigation

Feedback Loop: The feedback loop may improve future estimates by:
Storing predictions: Each time estimate is stored with a timestamp and current data snapshot.
Comparing predictions: Actual completion times are compared to predictions.
Calculating error: Mean Absolute Percentage Error (MAPE) is used to quantify prediction accuracy.
Adjusting models: Machine learning models (e.g., gradient boosting regressors) are trained on historical prediction data to improve future estimates.
Applying corrections: A correction factor based on historical accuracy is applied to new estimates.
Time-series prediction: The system tracks each experiment and uses advanced time-series prediction models like Neural Prophet to forecast outcomes and refine duration estimates.
This feedback loop allows the Time to Done system to learn from past experiments and continuously improve its prediction accuracy, adapting to the specific patterns and characteristics of experiments run on the platform.

Automatic Adjustment System: The system may include an innovative automatic adjustment feature that can modify experiment parameters in real-time to optimize outcomes:

Adjustable Parameters: The system can automatically adjust one or more of the following parameters:
1. Experiment Duration: Can extend the experiment beyond the initially set maximum days.
2. Sample Size: Ability to increase the number of visitors beyond the initial maximum.
3. Confidence Level (Frequentist): Can adjust the statistical confidence level.
4. Power Calculation Mode (Frequentist): Can switch between dynamic and fixed modes.
5. Decision Thresholds (Bayesian): Ability to modify Bayesian decision thresholds for chance to win and risk.

Adjustment Triggers: The system may initiate automatic adjustments based on the following triggers:
1. Proximity to Completion: Calculated as: (Elapsed Time/Estimated Total Duration)*100 Triggers adjustments when this value exceeds 80% and statistical goals are not met.
2. Unexpected Variability: Detected when the observed standard deviation exceeds 1.5 times the expected standard deviation.
3. Low Conversion Rates: Triggered when the observed conversion rate is less than 50% of the expected rate for more than 48 hours.
4. Time Constraints: Activated when the experiment reaches 90% of its maximum allowed duration without meeting statistical goals.

### Adjustment Algorithm

1. Evaluate current state against all triggers
2. Identify which triggers are activated
3. For each activated trigger, determine potential adjustments using the decision tree
4. Calculate the combined effect of all potential adjustments
5. Apply adjustments within user-defined limits (e.g., max 100% increase in duration)
6. Record all adjustments for later analysis
7. Re-run duration estimation with new parameters

### Enhanced Anomaly Detection and Outlier Removal

The system may employ advanced techniques for anomaly detection and automatic outlier removal to improve the quality of experimental data and accelerate experiment completion. This process may help reduce variance in metrics, leading to more reliable results in shorter time frames.

### Anomaly Detection Methods

### Statistical Process Control (SPC) Charts

The system may use Exponentially Weighted Moving Average (EWMA) control charts to detect shifts in conversion rates and other key metrics.

$$EWMA\_t = λ * X\_t + ( 1 - λ ) * EWMA\_ \{ t - 1 \}$$

Where X_t is the current observation, A is a smoothing factor (typically 0.1 to 0.3), and EWMA_{t−1} is the previous EWMA value.

Control limits are set at:

$$UCL / LCL = μ\_ 0 \neq {L}^{*} σ\_ {0}^{*} sqrt ( λ / {( 2 - λ )}^{*} {( 1 - λ )}^{∧} ( 2 t ) ) )$$

Where μ_0 and σ_0 are the in-control mean and standard deviation, and L is the width of the control limits (usually 3 for 99.7% confidence).

### Seasonal Decomposition

For metrics with known seasonal patterns, the system may use Seasonal and Trend decomposition using Loess (STL) to separate the time series into seasonal, trend, and residual components.

Anomalies may be identified in the residual component using statistical thresholds (e.g., 3 standard deviations from the mean).

### Isolation Forests

For high-dimensional data (e.g., multiple metrics per user), Isolation Forests may be used to detect outliers. This method may be particularly effective for identifying anomalies in large datasets with multiple features.

The anomaly score for an instance x may be defined as:

$$s ( x , n ) = 2 \hat{} ( - E ( h ( x ) ) / c ( n ) )$$

Where E(h(x)) is the average path length for x across multiple isolation trees, and c(n) is the average path length of unsuccessful searches in a binary search tree.

### Automatic Outlier Removal Process

Data Segmentation: The system may segment data by relevant factors (e.g., device type, traffic source) to ensure outlier detection is context-aware.

Multi-method Detection: may apply multiple detection methods (e.g., SPC, Seasonal Decomposition, Isolation Forests) to each segment.

Consensus Filtering: Data points are flagged as outliers only if identified by at least two methods, reducing false positives.

Modified Z Score: The Modified Z-score is an effective method for outlier detection and removal, particularly useful when dealing with non-normally distributed data or datasets with extreme outliers.

Documentation: All removed outliers are logged with their characteristics and impact scores for later review.

Adaptive Thresholds: The system may employ adaptive thresholds for outlier detection to account for evolving data patterns:

Initial thresholds may be set based on historical data or industry benchmarks.

As the experiment progresses, thresholds may be adjusted using a sliding window approach:

$$Adaptive Threshold = µ\_window \pm {k}^{*} a\_window$$

where μ_window and a_window are the mean and standard deviation of the metric in the current window, and k is a multiplier (typically 3-5).

Impact on Experiment Duration: The automatic outlier detection and removal process may contribute to faster experiment completion in several ways:

Reduced Variance: By removing extreme outliers, the variance of key metrics is reduced, leading to narrower confidence intervals.

Faster Convergence: With lower variance, the required sample size to achieve statistical significance is often reduced.

Improved Data Quality: Removing anomalous data points increases the signal-to-noise ratio, making it easier to detect true effects.

Dynamic Sample Size Adjustment: The system may recalculate required sample sizes after outlier removal, potentially shortening the experiment duration.

Safeguards and Monitoring: To ensure the integrity of the experiment, several safeguards may be put in place:

A maximum outlier removal percentage (e.g., 5% of total data) is enforced to prevent excessive data manipulation.

Regular audits of removed outliers are conducted to identify any systematic issues or biases in the detection process.

A/A tests are periodically run to calibrate the outlier detection system and ensure it doesn't introduce false positives.

All decisions made by the automatic outlier removal system are reversible, allowing for manual override if necessary.

User Interface: The system provides a comprehensive user interface for monitoring and control:

Visual Progress Bar: Displays progress from 0% to 100%, with color-coding to indicate experiment status.

Hover-Over Details: Shows unique users, sessions, visitors, days remaining, and estimated total duration.

Warning System: Highlights potential issues that may cause early experiment termination.

One-Click Adjustment Module: Allows manual adjustments based on real-time insights.

Integration with Third-Party Systems: Enables notifications and approvals through platforms like Slack, Microsoft Teams, and mobile applications.

### Assumptions:

Consistent Traffic Patterns: Assumes relatively stable traffic patterns throughout the experiment duration.

Data Accuracy: Relies on the accuracy and completeness of input data.

Statistical Assumptions: Underlying statistical methods have their own assumptions (e.g., normality for t-tests in Frequentist approach).

Adjustment Limits: Automatic adjustments are constrained by user-defined limits to prevent excessive modifications.

### Technical Advantages

Real-Time Analytics: may offer immediate insights and adjustments during experiments.

Accuracy and Adaptability: may provide high precision in duration estimation with the ability to adapt to new data.

Flexible Statistical Approach: may support both Frequentist and Bayesian methods with tailored progress and duration estimation algorithms.

Automated Decision-Making: may reduce manual intervention through intelligent automatic adjustments.

Comprehensive Monitoring: may provide a holistic view of experiment progress and potential issues.

This Time to Done system may represent a significant advancement in experiment duration estimation and management, offering unprecedented levels of accuracy, adaptability, and automation in the field of online experimentation. It may address the needs of both Frequentist and Bayesian statistical approaches, providing tailored solutions for each methodology.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A computer-implemented method for adaptive experiment management in an application environment, the method comprising:
receiving data associated with an experimental application, wherein the data comprises at least a start time, current progress, historical metrics, configuration parameters information, and user behavior data;
detecting anomalies in the received data using one or more machine learning models;
computing a projected completion time of the experimental application based on the received data, wherein the computation is based on a selection of one or more statistical models;
determining whether one or more adjustment conditions are met based on the computed projected completion time and the received data; and
in response to the determination that the adjustment conditions are met, modifying one or more experiment parameters for the experimental application;
generating one or more modified experiment parameters for the experimental application based on the modification to the one or more experiment parameters.

2. The method of claim 1, wherein the one or more statistical models comprise at least one of a frequentist statistical model and a bayesian statistical model.

3. The method of claim 2, wherein computing the projected completion time of the experimental application comprises calculating a sample collection rate and remaining duration using power analysis formulas when the statistical model is the frequentist statistical model, and wherein computing the projected completion time of the experimental application comprises computing a chance-to-win value and a risk value based on observed user behavior data when the statistical model is the bayesian statistical model.

4. The method of claim 1, further comprising applying variance reduction to the one or more experiment parameters using pre-experiment covariate data.

5. The method of claim 4, wherein the variance reduction comprises Controlled-experiment Using Pre-Experiment Data (CUPED) adjustment.

6. The method of claim 1, wherein the adjustment conditions include one or more of: experiment progress falling below a minimum threshold, observed variance exceeding a predetermined limit, a projected completion date exceeding a maximum duration, and a conversion rate deviation exceeding a target margin.

7. The method of claim 1, wherein the modification to the experiment parameters comprises at least one of: experiment duration, required sample size, statistical confidence threshold, and decision rule for terminating the experiment.

8. The method of claim 1, further comprising displaying the one or more modified experiment parameters to a user via a graphical user interface or transmitting the one or more updated experiment parameters to an external application programming interface (API).

9. The method of claim 1, wherein the experimental application is a unit under test (UUT), wherein the data received comprises online experiment data associated with the UUT, wherein the data is received by monitoring user interaction with the UUT, and wherein the UUT is hosted on a first computing device and is monitored from a second computing device.

10. A system for adaptive experiment management in an application environment, comprising:
a processor operatively coupled to a memory, the memory storing instructions that, when executed by the processor, cause the system to:
receive data associated with an experimental application, wherein the data comprises at least a start time, current progress, historical metrics, configuration parameters, and user behavior data;
detect anomalies in the received data using one or more machine learning models;
compute a projected completion time of the experimental application based on the received data, wherein the computation is based on a selection of one or more statistical models;
determine whether one or more adjustment conditions are met based on the computed projected completion time and the received data;
in response to the determination that the adjustment conditions are met, modify one or more experiment parameters for the experimental application; and
generate one or more modified experiment parameters based on the modification to the one or more experiment parameters.

11. The system of claim 10, wherein the one or more statistical models comprise at least one of a frequentist statistical model and a bayesian statistical model.

12. The system of claim 11, wherein to compute the projected completion time of the experimental application, the processor is configured to calculate a sample collection rate and remaining duration using power analysis formulas when the statistical model is the frequentist statistical model, and wherein to compute the projected completion time of the experimental application, the processor is configured to compute a chance-to-win value and a risk value based on observed user behavior data when the statistical model is the bayesian statistical model.

13. The system of claim 10, wherein the processor is configured to apply variance reduction to one or more experiment parameters using pre-experiment covariate data.

14. The system of claim 13, wherein the variance reduction comprises Controlled-experiment Using Pre-Experiment Data (CUPED) adjustment.

15. The system of claim 10, wherein the adjustment conditions include one or more of: experiment progress falling below a minimum threshold, observed variance exceeding a predetermined limit, a projected completion date exceeding a maximum duration, and a conversion rate deviation exceeding a target margin.

16. The system of claim 10, wherein the modification to the experiment parameters comprises at least one of: experiment duration, required sample size, statistical confidence threshold, and a decision rule for terminating the experiment.

17. The system of claim 10, wherein the processor is further configured to display one or more modified experiment parameters to a user via a graphical user interface or transmit the one or more updated experiment parameters to an external application programming interface (API).

18. The system of claim 10, wherein the experimental application is a unit under test (UUT), wherein the data received comprises online experiment data associated with the UUT, wherein the data is received by monitoring user interaction with the UUT, and wherein the UUT is hosted on a first computing device and monitored from the system.

19. A computer readable storage medium having data stored therein representing software executable by a computer, the software comprising instructions that, when executed, cause the computer readable storage medium to perform:
receiving data associated with an experimental application, wherein the data comprises at least a start time, current progress, historical metrics, configuration parameters information, and user behavior data;
detecting anomalies in the received data using one or more machine learning models;
computing a projected completion time of the experimental application based on the received data, wherein the computation is based on a selection of one or more statistical models;
determining whether one or more adjustment conditions are met based on the computed projected completion time and the received data; and
in response to the determination that the adjustment conditions are met, modifying one or more experiment parameters for the experimental application; and
generating one or more modified experiment parameters for the experimental application based on the modification to the one or more experiment parameters.

20. The computer readable storage medium of claim 19, wherein the one or more statistical models comprise at least one of a frequentist statistical model and a bayesian statistical model.
